(19) United States
(12) Patent Application Publication
(10) Pub. No.: US 2006/0075213 A1
(43) Pub. Date: Apr. 6, 2006

(54) Modular integration of an array processor within a system on chip

(75) Inventors: Geoffrey F Burns, Ridgefield, CT (US); Krishna Vaidyanathan, Bannerghatta Road^M, IN (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILLIPS ELECTRONICS N.C.

(21) Appl. No.: 10/538,369

(22) PCT Filed: Nov. 28, 2003
(86) PCT No.: PCT/IB03/05625

§ 371 Date: Jun. 13, 2005

(30) Foreign Application Priority Data
Dec. 12, 2002 (US) 60432801
Jun. 13, 2003 (US) 60478333

(51) Int. Cl. G06F 9/30; G06F 9/44

(52) U.S. Cl. 712/241; 712/218

(57) ABSTRACT

A systolic array processor is integrated within a system on chip (SoC) in a format that is compatible with existing and emerging SoC technologies. The systolic array processor may be implemented as a co-processor to a general-purpose digital signal processor or as a functional unit of a very long instruction word (VLIW) processor.

The present invention relates to processing systems on an integrated circuit that include an array processor as a functional unit or coprocessor, and particularly to integrated systems that include a reconfigurable array processor.

An embedded system is some combination of hardware or software that is specifically designed for a particular purpose or application within an overall system, and may be fixed in capability or programmable. A mobile phone may, for example, have a power saving integrated circuit (IC) or “chip” operable only with its respective type of phone and devoted exclusively to controlling the display and other elements to conserve power.

The same mobile phone typically includes a digital signal processing integrated circuit, which executes the functions on a digital portion of the radio. In order to adapt to different and/or changing radio broadcast formats of an incoming signal, programmable radios would be desirable. However, digital radio processing functions can entail high data sample rates, along with high computational loads, that are typically impractical to implement on programmable hardware.

A typical approach to accommodate the computational load within the capabilities of the programmable hardware is to design hardware acceleration modules that specialize in efficient computation of high-data rate and/or computational rate algorithms. The accelerators may be interfaced with the programmable processor using a number of techniques, each of which allow the programmable processor to control the operation of the accelerator, as well as to properly schedule the data to be exchanged with the accelerator. For instance, a general purpose DSP or other host may have a set of internal register addresses that are visible within the instruction set of the processor, but are mapped to input and output ports of a coprocessor interface. The accelerator inputs and outputs may be connected to this interface, and process data under control of the programmable processor. In this way proper data exchange is programmable by the general purpose device.

In another approach the general purpose programmable host or DSP allows new, high-speed functional units to be inserted into its datapath. The functional unit responds to instruction operation codes provided by the hierarchical controller, and exchanges data with internal register files and other units according the datapath configuration specified by the hierarchical controller.

While these approaches succeed in offloading excess computational loads from a programmable processor, they rely on accelerators with limited or no programmability to execute the computation-intensive tasks. In this manner an important element of the programmability has been lost.

The present invention is directed to the integration of an array processor as a reconfigurable accelerator to a host or main processor, the array processor greatly exceeding the execution processing capacity of the host processor. The coprocessor includes a two-dimensional array of processing cells. The coprocessor is communicatively connected to the host processor by an interface module that has a mechanism for reconfiguring information paths between itself and respective cells on a periphery of the array.

In another aspect, this invention relates to a host or main processor's functional unit, where the host processor is preferably a very long instruction word (VLIW) processor, and the functional unit preferably embodies a two-dimensional array of processing cells having an interface by which information paths to the array through respective cells on a periphery of the array can be reconfigured.

Details of the invention disclosed herein shall be described below, with the aid of the figures listed below, in which same or similar components are denoted by the same reference numbers over the several views:

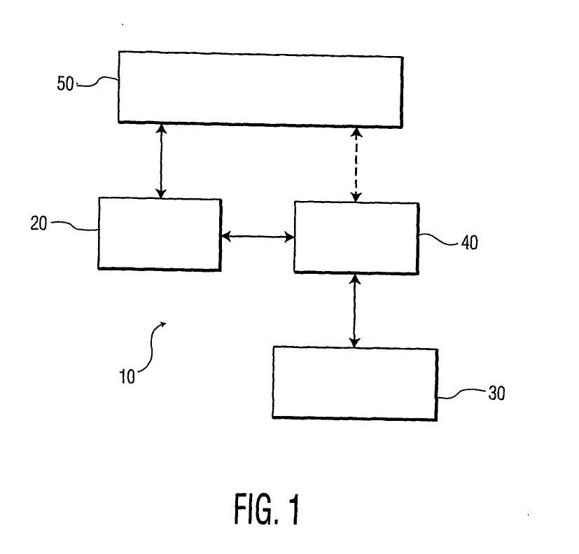

FIG. 1 is a block diagram illustrating a processor/co-processor arrangement in accordance with the present invention

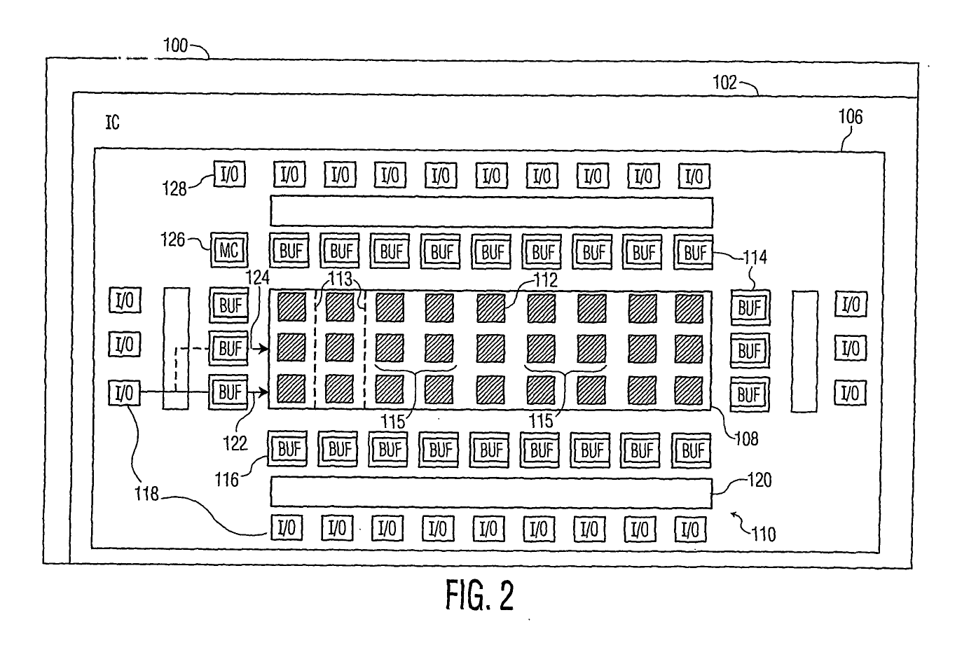

FIG. 2 is a schematic diagram showing an example of a device having an embedded array processor in accordance with the present invention;

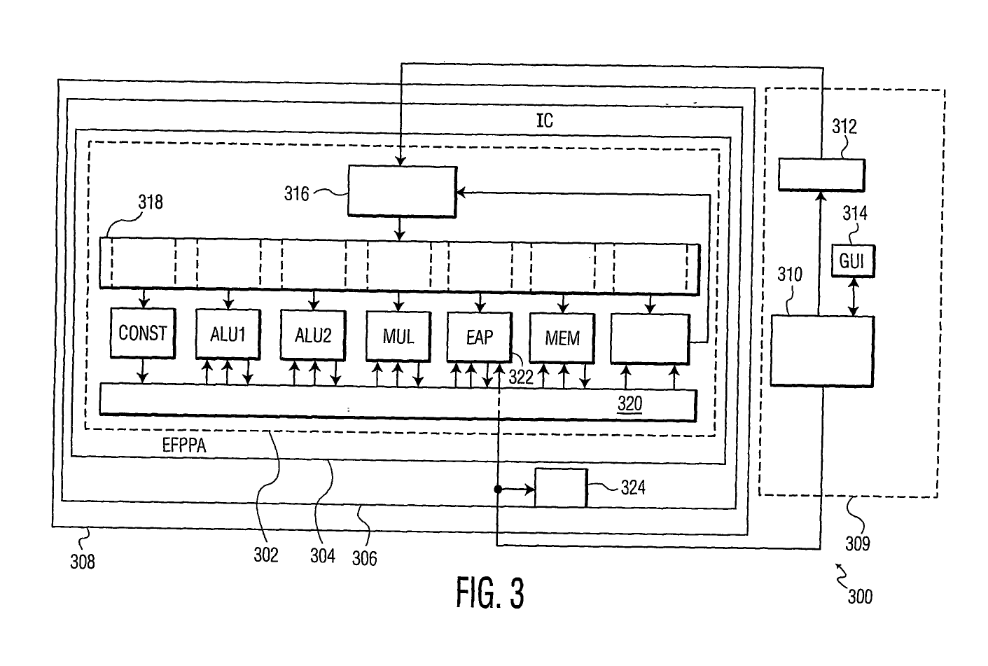

FIG. 3 is a block diagram of an implementation of the array processor of FIG. 2 as a functional unit within a VLIW processor; and

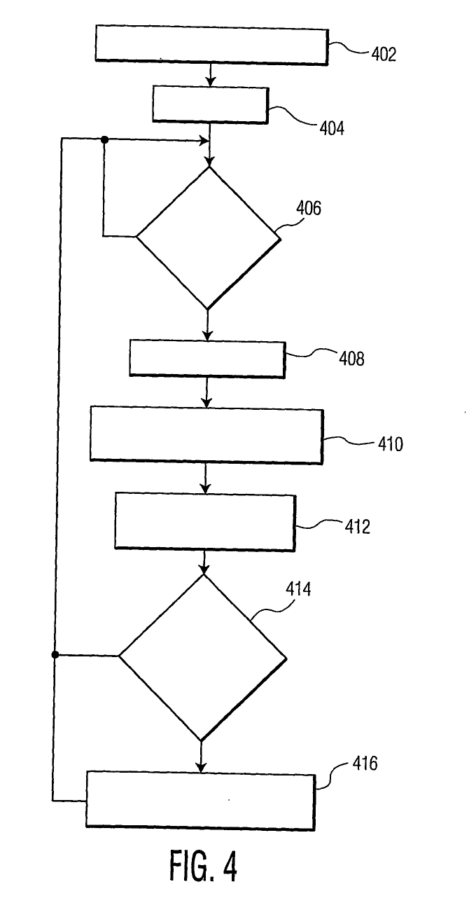

FIG. 4 is a set of flow diagrams that depict exemplary flow of processing in initializing and updating of programs to be executed on the array processor of FIG. 3

FIG. 1 depicts an example of a connection arrangement 10 between a general-purpose digital signal processor (DSP) or micro-controller 20 and its closely-coupled co-processor 30, implemented as a two-dimensional array. The co-processor 30 assists the DSP 20 in performing certain types of operations. The execution speed of the co-processor 30, often expressed in millions of instructions per second (MIPS), is faster than that of the DSP 20. Accordingly, in partitioning functionality between the processors, the co-processor would embody the high-MIPS signal chain. The co-processor 30 is communicatively connected to the DSP 20 by and interface module 40. The DSP 20 utilizes a memory system 50. In one embodiment, the DSP 20 and its co-processor 30 communicate directly by means of the interface module 40. In another embodiment, the interface module 40 is communicatively connected to the memory system 50 to thereby provide a communications path, or and additional communications path, between the DSP 20 and the co-processor 30. In the latter embodiment, processor synchronization is implemented in preferably one or more of the modules 20, 30, 50.

FIG. 2 shows an exemplary embodiment of an apparatus that may be configured to incorporate the arrangement 10 shown in FIG. 1. A receiver 100, such as one in a broadcast or cable television receiver, local area network wireless receiver or mobile phone receiver, contains an IC 102. The IC 102 includes an embedded array processor 106. An array processor is a processor capable of executing instructions that operate on input that may consist of arrays. The embedded array processor 106 has a two-dimensional rectangular array 108 and a mechanism or interface 110 which is shown in FIG. 2 to surround the array 108 on all four edges. The two-dimensional array 108 is composed of processing cells 112.

The IC 102 may, for example, be configured in accordance with the arrangement 10 in FIG. 1, where the array 108 is implemented as the array 30 and the interface 110 corresponds to the interface module 40. As will be discussed below, other additional alternatives for implementing IC 102 are contemplated.

Preferably, inter-cell connection within the array 108 is such that each cell 112 is connected only to cells 112 whose column is the same and whose row is immediately adjacent, and only to cells 112 whose row is the same and whose column is immediately adjacent, to realize a “nearest neighbor” connection architecture, as shown in FIG. 2 of commonly owned U.S. Patent Publication No. 2003/0065904, filed Oct. 1, 2001, (hereinafter the '904 application), the entire disclosure of which is incorporated herein by reference. Since inter-cell connection is purely nearest-neighbor, the array offers the flexibility of being scalable.

In one embodiment, the interface 110 has border cells 114 connected to each respective processing cell 112 on the periphery of the array 108, each border cell 114 having a buffer 116. The periphery preferably consists of those processing cells 112 which are located on the array edges, i.e., in at least one of the first row, last row, first column and last column. Since internal array connection cell-to-cell, under the nearest neighbor scheme, leaves two neighbors missing for each corner cell 112 and one neighbor missing for each other cell 112 on array edges, the missing connections are each made to a corresponding border cell 114.

Further included in the interface 110 are input/output (I/O) pads 118, one for each border cell 114, and a crossbar network 120 for reconfigurably connecting each I/O pad 118 one-to-one to a corresponding border cell 114. For each such connection an information path is formed. FIG. 2 shows an information path 122 that includes an I/O pad 118, the crossbar network 120 and a border cell 114. Reconfiguring a path causes the path to traverse either a different border cell 114, a different I/O pad 118, or both. The path 124 is a reconfiguration of the path 112 to traverse a different border cell 114. Reconfigurable routing can alternatively be accomplished via a local selection mechanism in each border cell, rather than by a crossbar network.

In a preferred embodiment, the array processor 105 is a systolic processing array, a special-purpose system which can be likened to an assembly line for input operands, although operations typically proceed not in a strictly linear direction but in changing directions. In a two-dimensional array of processing cells, differing mathematical operations are performed on the data by different cells, while data proceeds in an orderly, lock-step progression from one cell to another. An example of a systolic array would be one that multiplies matrices. Entries of a row are multiplied by corresponding entries of a column, and the products are summed to produce an ordered column of sums. Efficiency is achieved by arranging operations to be performed in parallel, so that the results are produced in the fewest clock cycles. The '904 application provides another example of a systolic processing array, implementing a 32-tap real finite impulse response (FIR) filter. The filter is enhanced by concatenating other levels, two-dimensional and otherwise, to the original two-dimensional array, border cells being connected to processing cells on the periphery of each level. Such an enhanced array, connected by the border cells 114, is also within the intended scope of the present invention.

In one embodiment, the border cells 114 not only provide input to the array 108. They also provide results of array processing to the I/O pads 118. The border cells 114 receive these results by neighbor to neighbor conveyance from the processing cells 112 producing the results. Optionally, the border cell 114 may validate the results and output a data valid signal to the external process, such as the DSP 20.

In a preferred embodiment, the IC 102 includes a memory, such as in memory system 50, from which array programs are downloaded by means of a bus 113 to corresponding processing cells 112. The memory is preferably a random access memory (RAM) or other writeable storage device so that updated array programs can be provided, as by an array generator external to the receiver 100.

The system controller which may be an external processor passes array programs to a master cell 126 of the embedded array processor 106 over a configuration bus such as the random access configuration bus shown in FIG. 16 of the '904 application. As discussed in the pending, commonly owned patent application entitled “DATAFLOW-SYNCHRONIZED EMBEDDED FIELD PROGRAMMABLE PROCESSOR ARRAY,” based on Philips disclosure 703366, hereinafter the “EFPPA application,” the entire disclosure of which is incorporated by reference herein, the master cell 126 forwards the array programs to the appropriate processing cells 112 at system initialization or upon reconfiguration, e.g. implementation of a new algorithm for the processing array 106. Due to the parallelism inherent in systolic processing, some of the processing cells 112 may receive identical programs. An identical program may, for example, be downloaded to a subset of the processing cells 112 such as subset 115 shown in FIG. 2. The EFPPA application further discusses processing by the border and master cells and a preferred implementation using a Kahn process network.

The array processor 106 performs mathematical operations whose timing is based on a flow of input operands along the paths providing the operands to the array 108.

Array programs may be prepared using a graphical user interface (GUI) that can edit and show the code to be downloaded to RAM on the IC 102 and then to each programming cell 112.

In an alternative exemplary implementation 300 of the embedded array processor 106 of FIG. 2, FIG. 3 depicts a host VLIW processor 302 as a component of an EFPPA 304 of the “in circuit” programmable type. EFPPA 304 is implemented on an IC 306 contained within a receiver 308. The host VLIW processor 302 is connected to a chip development platform 309, and, in particular, to an array program generator 310 and a compiler 312 within the platform 309. The array program generator 310 is further connected to a graphical user interface 314 of the platform 309.

The VLIW processor 302 includes an instruction memory 316, and instruction issue register 318, a shared, multiported register file 320. Also included within the processor 302, and, connected to both the file 320 and the register 318 at corresponding issue slots, are a plurality of functional units. Details of this VLIW architecture are provided in commonly owned U.S. Pat. No. 5,974,537, filed Oct. 26, 1999, (hereinafter the '537 patent), the entire disclosure of which is incorporated herein by reference. The functional unit 322 can be realized, for example, as the embedded array processor 106 of FIG. 2 in the present application, with the IC 306 corresponding to IC 102, and with the receiver 308 corresponding to receiver 100. In the '537 patent, the functional unit 322 executes floating point instructions, although the unit 322 is not confined to any particular type of processing. For example, a two-dimensional array is disclosed in the '904 application to perform finite impulse response (FIR) filtering and fast Fourier Transforms (FFT's) useful in channel decoding and other applications.

FIG. 4 demonstrates exemplary flow of processing in initializing and updating of programs to be executed on the array processor 322 of FIG. 3. At system initialization, array programs for each of the processing cells 112 generated by the array program generator 310 (step 402) are downloaded to a RAM 324 on IC 306 (step 404). A system controller (not shown) subsequently downloads the array programs to the master cell 126 which distributes them to the corresponding array cells 112. The master cell 126 accordingly transmits a plurality of array programs to corresponding predetermined subsets of the processing cells 112, the cells in each subset of one more cells receiving an identical array program.

When an array program is updated, as by a user of the chip development platform 309 through interactive utilization of the GUI 314 and by means of the array program generator 310 (steps 406, 408), changes in the program may affect the timing of functional unit 322 input and/or output. The compiler 312 needs to know this timing change for scheduling purposes in forming the VLIW instruction. The array program generator 310 therefore updates this I/O timing data and transmits it to the compiler 312 (step 410). The updated array program is downloaded (step 412), as described above with regard to system initialization. The array program generator 310 determines whether the program change affects a steady state connection pattern of the interface 110. The steady state pattern defines, for example, which I/O pads 118 are connected to which border cells 114 at which stages of a mathematical operation, i.e., the mathematical operation may accept input operands at the array periphery at multiple stages of the operation. If the program update changes the steady state pattern (step 414), the array program generator 310 sends a reconfigure signal to the functional unit 322 (step 416). Preferably, the signal is received by the master cell 126, which then effects the needed connection timings in the crossbar switch 120.

Although array program functionality has been described in the context of the VLIW processor 302 of FIG. 3, the same functionality, except for the timing data protocol, applies as well to the coprocessor arrangement 10 of FIG. 1. In fact, even the timing data protocol applies if the co-processor is implemented as a VLIW processor.

While there have been shown and described what are considered to be preferred embodiments of the invention, it will, of course, be understood that various modifications and changes in form or detail could readily be made without departing from the spirit of the invention. For example, alternatively implemented, the system controller 104 and RAM may instead reside within the embedded array processor 106. It is therefore intended that the invention be not limited to the exact forms described and illustrated, but should be constructed to cover all modifications that may fall within the scope of the appended claims.

1. A coprocessor to a main processor having an execution speed greater than that of said processor, the coprocessor comprising a two-dimensional array of processing cells and being communicatively connected to said processor by an interface module having a mechanism for reconfiguring a plurality of information paths between the interface module and respective cells on a periphery of the array.

2. The coprocessor of claim 1, wherein the array comprises a systolic processing array.

3. The coprocessor of claim 1, wherein the paths are connected one-to-one with said respective cells.

4. The coprocessor of claim 1, wherein the coprocessor performs mathematical operations whose timing is based on a flow of input operands along the paths.

5. The coprocessor of claim 1, wherein inter-cell connection within the array is such that each cell of the array is connected only to cells whose column is the same and whose row is immediately adjacent, and only to cells whose row is the same and whose column is immediately adjacent.

6. A coprocessing system including the coprocessor interface module and main processor of claim 1 and a shared memory that communicatively connects with the interface module and the main processor to provide the main processor to coprocessor connection.

7. The coprocessor of claim 1, including an array processor that comprises said two-dimensional array.

8. An integrated circuit comprising the coprocessor of claim 1.

9. A receiver comprising the integrated circuit of claim 8.

10. The coprocessor of claim 1, wherein said array is rectangular and said periphery consists of those of said processing cells located in at least one of a first row, last row, first column and last column of said array.

11. The coprocessor of claim 1, wherein said processor comprises a digital signal processor.

12. The coprocessor of claim 1, wherein said processor (20) comprises a general purpose processor.

13. A functional unit having a two-dimensional array of processing cells and serving as a component of a main processor, the unit having a mechanism for reconfiguring a plurality of intra-processor information paths to the array to respective cells on a periphery of the array.

14. The unit of claim 13, wherein said processor comprises a very long instruction word (VLIW) processor.

15. The unit of claim 13, wherein inter-cell connection within the array is such that each cell of the array is connected only to cells whose column is the same and whose row is immediately adjacent, and only to cells whose row is the same and whose column is immediately adjacent.

16. The unit of claim 13, further including means for transmitting a plurality of array programs to corresponding predetermined subsets of said processing cells.

17. A system including the processor of claim 16, and an array program generator for generating the array programs to be transmitted, and, when needed, updating a program (106), transmitting the updated program, and transmitting concurrently, when needed, a reconfigure signal to said mechanism to correspondingly update a current steady state connection pattern of said information paths.

18. The system of claim 17, further including a compiler configured for receiving, in response to said program updating data representative of input and output timing for said unit and further configured for compiling an instruction based on said data.

19. An integrated circuit comprising the processor of claim 13.

20. A method for interfacing a coprocessor to a main processor, comprising the steps of:
configuring the coprocessor to comprise a two-dimensional array of processing cells and to have an execution speed greater than that of said processor; and
communicatively connecting the coprocessor to said processor by an interface module having a mechanism for reconfiguring a plurality of information paths between the interface module and respective cells on a periphery of the array.
